(19) United States
(12) Patent Application Publication
(10) Pub. No.: US 2024/0316815 A1
(43) Pub. Date: Sep. 26, 2024

(54) Rotary Die Cutting Deflection Reducing Apparatus and Method for Corrugated Article Converting

(71) Applicant: Sun Automation, Inc., Glen Arm, MD (US)

(72) Inventor: Thad Fullem, Felton, PA (US)

(73) Assignee: Sun Automation, Inc., Glen Arm, MD (US)

(21) Appl. No.: 18/607,866

(22) Filed: Mar. 18, 2024

Related U.S. Application Data
(60) Provisional application No. 63/453,885, filed on Mar. 22, 2023.

(51) Int. Cl. B26D 7/20; B31B 50/14

(52) U.S. Cl. CPC B26D 7/20; B31B 50/14; B26D 2007/202

(57) ABSTRACT

Certain embodiments disclose a rotary die cutting apparatus including a rotatable first cylinder, a rotatable second cylinder positioned in proximity to the first cylinder to compress and permit cutting and/or creasing of a corrugated article when the corrugated article passes between the first and second cylinders, a pivot arm on which the second cylinder is mounted and configured for pivotal movement to thereby move the second cylinder mounted thereon relative to the first cylinder, and a displacement actuator operatively connected to the pivot arm to control the pivotal movement of the pivot arm. Other embodiments disclose a method for controlling movement of a second cylinder relative to a first cylinder.

### CROSS-REFERENCE TO RELATED APPLICATION AND CLAIM OF PRIORITY

This application claims the benefit of priority of U.S. Provisional Application No. 63/453,885 filed Mar. 22, 2023, the complete disclosure of which is incorporated herein by reference and priority to which is hereby claimed.

### BACKGROUND

Embodiments disclosed herein relate to apparatus, systems, and methods for processing corrugated articles (e.g., paper), including apparatus, systems, and methods relating to corrugated box-making machines and processes.

Rotary die cutters include a die drum or a cylinder having on its surface a cutting die typically made of steel rule for cutting or creasing corrugated board against an anvil drum or cylinder. This process occurs as the board passes between the two drums. The anvil cylinder is circumferentially covered with 10-inch to 20-inch wide and initially 0.420-inch to 0.300-inch thick urethane blankets. As knives on the die drum cut the corrugated boards, the anvil urethane blankets wear down and change thickness.

Surface speed of the anvil affects the accuracy of the die cut of the corrugated board. Ideally the surface speed of the anvil drum should be equal to the linear speed of the board as the board travels through the die cutter. As the urethane blankets wear, the overall diameter of the anvil drum decreases, which reduces the surface speed of the anvil drum and ultimately changes the cut size of the produced corrugated board.

Several systems exist to compensate for the change in diameter of the anvil drum by changing the rotational speed of the anvil drum in accordance with the change of the anvil drum diameter. On some systems, the die cutter operator manually measures the diameter of the anvil drum and then inputs the measurement into a control system, which then changes the rotational speed of the anvil drum. To provide for the fine anvil drum speed adjustment, an operator usually tries to “fool the system” and inputs a number in the control system that is higher or lower than the number corresponding to the real anvil drum diameter. This method is not accurate and requires several “trial and error” attempts. Also, a significant change of this number results in a large difference between the surface speeds of the die drum and the anvil drum, which can lead to additional stresses on the die cutter components and the breaking of the die-cutter knives. Also, there are no provisions for the control system to “remember” this number, so when the same die is used the next time, the operator must repeat the “trial and error” procedure.

U.S. Pat. No. 6,609,997, owned by the Applicant of the present application (i.e., Sun Automation Inc.), discloses an improved system in which the position of the anvil grinding or trimming mechanism determines the diameter of the anvil drum automatically. The system includes a computer that feeds this information into a control system, which changes the rotational speed of the anvil drum. However, even if the surface speed of the anvil drum is perfectly correlated with the drum diameter, it may still be necessary to fine-adjust the surface speed of the anvil drum within a small range, usually +/−3%, to achieve a perfectly sized corrugated box. One reason for this fine adjustment is to compensate for an imperfection of the cutting and creasing die that is mounted on the surface of the die drum. Another reason for this fine adjustment may be the change in the amount of impression of the die cutter knives and blades into the anvil.

U.S. Pat. No. 6,913,566, also owned by the Applicant of the present application, discloses a rotary die cutter for cutting and/or creasing corrugated boards in a box-making machine. The rotary die cutter includes a rotatable die cylinder having at least one cutting die, and a rotatable anvil against which the corrugated boards are cut as they pass between the die cylinder and anvil. A method of adjusting a length dimension to be cut on the board by the die cutting components includes using a computer for determining how much the speed of the anvil should be changed to cut the board at a desired length dimension, and providing an information input to the computer representative of the specific die used on the die cylinder for the purpose of calculating an adjusted speed of the anvil to cut the board at the desired length dimension. The computer sends a signal to a motor for changing the speed of the anvil to the adjusted speed calculated by the computer.

Referring to FIG. 1, which is reproduced from U.S. Pat. No. 6,913,566, a rotary die cutter apparatus of the corrugated box making machine 1 includes a cutting die cylinder 2 with fixed running diameter and an anvil cylinder 3, which receive in their nip corrugated boards 4 to be cut or creased by a cutting die, which uses steel rules 5 to cut corrugated boards against the anvil cylinder 3. The anvil cylinder includes steel drum and anvil blankets 6 typically made of urethane, which are wrapped and fixed around the surface of the steel drum.

As the sheets of corrugated paper run through the die cutter, the blades of the cutting and creasing die 5 penetrate through the anvil blankets 6 to obtain the desired cutting and scoring effect. This causes the anvil blankets 6 to wear down and changes the overall diameter of the anvil. To achieve high dimensional stability of the produced corrugated boxes, both the die cylinder 2 and the anvil cylinder 3 are driven with the same surface speed.

As the anvil blankets 6 wear, it is desirable to increase the rotational speed of the anvil cylinder 3. The goal is to match the linear speed of the outer surface of the anvil cylinder to the running linear speed of the die cylinder 2, which equals the linear speed of the corrugated sheet passing through the die cutter.

According to an embodiment described in the Abstract of U.S. Pat. No. 6,913,566, a computer 9 is used to determine how much the speed of the anvil cylinder 3 should be changed to compensate for changes in the diameter of the anvil cylinder 3 so that the boards 4 are cut to the desired dimension. A fine adjustment of the size of the boards 4 to be cut is made by providing information to the computer representative of the specific die being used. The computer 9 calculates an adjusted speed of the anvil cylinder 3 to cut the boards 4 to the desired dimension, and then sends a signal to a motor for changing the speed of the anvil cylinder 3 to the adjusted speed calculated by the computer.

Another problem with rotary die cutters, such as those of box makers, is that the rotary die cutters experience die cut and anvil drum deflection during high-speed, severe-pressure production runs. The deflection of the drums can cause the knives and creasing rule on the die board to not fully penetrate and crease the center of the corrugated board. This creates problems with un-attached pieces of scrap and poor box erection in customers packing machinery. The excessive pressure required to overcome the deflection could cause machine breakdowns and lost productivity. The inventor has found that it would be advantageous to maintain spacing between drums to reduce or eliminate this problem.

The inventor has found that insight to the quantified pressure between the rolls or drums can be a valuable indicator of tooling condition, machine condition, or operational parameter optimization.

### OBJECTS AND SUMMARY

In a first aspect, a rotary die cutting apparatus including a rotatable first cylinder, a rotatable second cylinder positioned in proximity to the first cylinder to compress and permit creasing and/or cutting of a corrugated article when the corrugated article passes between the first and second cylinders, a pivot arm on which the second cylinder is mounted and configured for pivotal movement to thereby move the second cylinder mounted thereon relative to the first cylinder, and a displacement actuator operatively connected to the pivot arm to control the pivotal movement of the pivot arm.

A second aspect provides a method of operating a rotary die cutting apparatus. The rotary die cutting apparatus includes a rotatable first cylinder, a rotatable second cylinder positioned in proximity to the first cylinder to compress and permit creasing and/or cutting of a corrugated article when the corrugated article passes between the first and second cylinders, a pivot arm on which the second cylinder is mounted and configured for pivotal movement to thereby move the second cylinder mounted thereon relative to the first cylinder, and a displacement actuator operatively connected to the pivot arm to control the pivotal movement of the pivot arm. According to the embodied method, the corrugated article is passed between the first and second cylinders to cause the first cylinder and/or the second cylinder to cut and/or crease the corrugated article.

It should be understood that the above-described aspects and embodiments may be combined with one another in any combination and may be modified to include, for example, one or more embodiments described herein, including in the detailed description below and in the accompanying drawings.

The above and still further objects, features and advantages of certain aspects and embodiments will become apparent upon consideration of the following detailed description of exemplary embodiments, particularly when taken in conjunction with the accompanying drawings, wherein like reference numerals in the various figures are utilized to designate like components.

### BRIEF DESCRIPTION OF THE SEVERAL VIEWS OF THE DRAWINGS

The drawings referenced herein form a part of the specification and are incorporated herein by reference. Features shown in the drawings are meant as illustrative of only some embodiments, and not of all embodiments, unless otherwise explicitly indicated.

FIG. 1 is a schematic view of a known box making machine embodied in U.S. Pat. No. 6,913,566.

FIG. 2 is a schematic view of a known box making machine embodied in U.S. Pat. No. 6,913,566.

FIG. 3 is a perspective view of a rotary die cutting apparatus according to an exemplary embodiment.

FIG. 4 is an end view of the rotary die cutting apparatus embodied FIG. 3.

FIG. 5 is a front cross-sectional view of the rotary die cutting apparatus embodied in FIG. 3.

FIG. 6 is a perspective view of the rotary die cutting apparatus embodied in FIG. 3, with end stanchions or frames illustrated as transparent.

FIG. 7 is an end view of the rotary die cutting apparatus embodied in FIG. 3, with end stanchions or frames illustrated as transparent.

FIG. 8 is a side view of the rotary die cutting apparatus embodied in FIG. 3.

FIG. 9 is an enlarged, fragmented, perspective view of the rotary die cutting apparatus embodied in FIG. 3.

FIG. 10 is an isolated, enlarged, side view of a stanchion (also referred to herein as a frame member) of the rotary die cutting apparatus embodied in FIG. 3.

FIG. 11 is an isolated, enlarged, perspective view of pivot plates or pivot arms of the rotary die cutting apparatus embodied in FIG. 3.

FIG. 12 is an isolated, enlarged, perspective view of a pivotal base for a displacement actuator of the rotary die cutting apparatus embodied in FIG. 3.

FIG. 13 is an enlarged, fragmented view of a second end of a die cylinder of the rotary die cutting apparatus embodied in FIG. 3.

FIG. 14 is an enlarged, fragmented view of a journal for a first end of the die cylinder embodied in FIG. 13.

FIG. 15 is an enlarged, fragmented view of a second end of an anvil cylinder of the rotary die cutting apparatus embodied in FIG. 3.

FIG. 16 is an enlarged, fragmented view of a journal for a first end of the anvil cylinder embodied in FIG. 15.

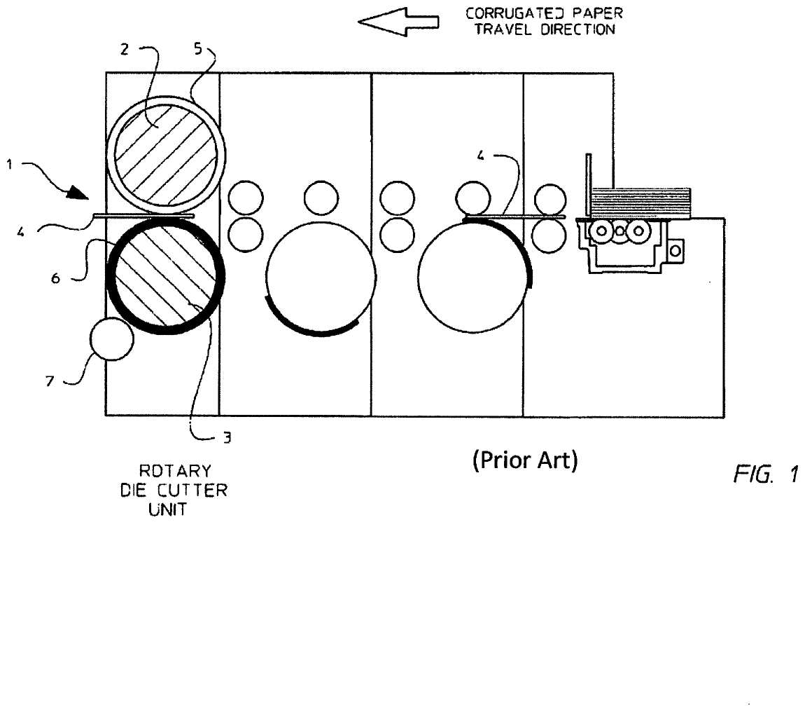

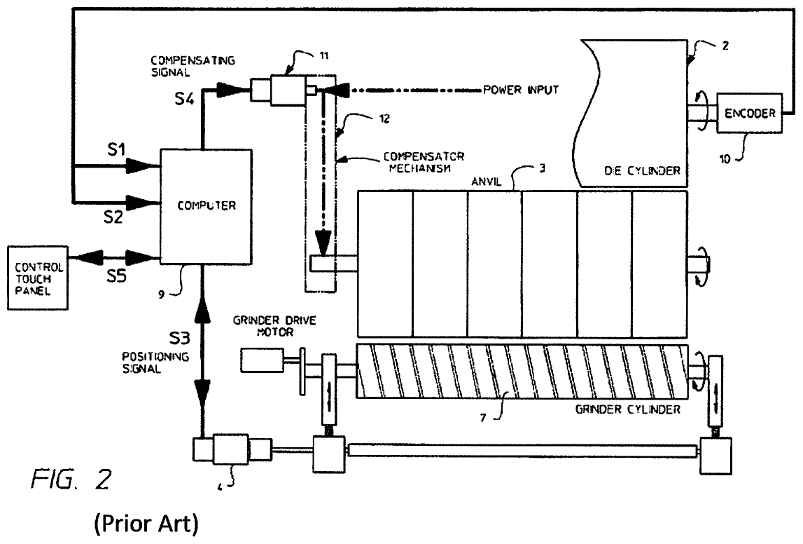

### DETAILED DESCRIPTION OF THE EXEMPLARY EMBODIMENTS

It will be readily understood that the components and features of the exemplary embodiments, as generally described herein and illustrated in the Figures, may be arranged and designed in a wide variety of different configurations. Thus, the following detailed description of the embodiments of the methods, devices, assemblies, apparatus, systems, etc. of the exemplary embodiments, as presented in the Figures, is not intended to limit the scope of the embodiments, as claimed, but is merely representative of selected embodiments.

The illustrated embodiments will be best understood by reference to the drawings, wherein like parts are designated by like numerals throughout. The following description is intended only by way of example, and illustrates certain selected embodiments of methods, devices, assemblies, apparatus, systems, etc. that are consistent with the embodiments as claimed herein.

Reference throughout this specification to “a select embodiment,” “one embodiment,” “an exemplary embodiment,” “exemplary embodiments,” “an embodiment,” or “embodiments” or the like means that a particular feature, structure, or characteristic described in connection with the embodiment(s) is included in at least one embodiment. Thus, appearances of the phrases “in a select embodiment,” “in one embodiment,” “in an exemplary embodiment,” “in exemplary embodiments,” “in an embodiment,” or “in embodiments” or the like in various places throughout this specification are not necessarily referring to the same embodiment(s) or only a single embodiment. The embodiments may be, for example, combined with one another in various combinations and modified to include features of one another.

According to embodiments disclosed herein, system and methods are designed to reduce deflection between the die drum and anvil drum on a rotary die cutter used in, for example, a corrugated-paper finishing press. The system and method of embodiments involve use of an anvil drum, and in exemplary embodiments an over-sized anvil drum, and a pivot-mounted adjusting actuator to reduce separation between the die and anvil drums when cutting and creasing corrugated board. The actuator of certain embodiments also enables the ability to sense the load between the anvil drum and die drum due to the more direct adjustment action compared to an eccentric adjustment mechanism.

In at least one embodiment described herein, the die drum diameter is not changed due to the machine repeat and surface speed required. In the at least one embodiment, the die drum rotation equates to a fixed output length of the produced board or box. For example, in a particular embodiment, the repeat diameter is 21 inches to provide a linear output of 66 inches. In at least one embodiment, the anvil drum does not have a repeat, but matches the linear velocity of the die drum. In at least one embodiment, to reduce deflection under a cutting load, the anvil drum diameter can be increased. However, as indicated above, the anvil drum has no relationship to the machine repeat, but only matches the surface speed of die drum. Increasing the diameter of the anvil drum significantly reduced its deflection and flexibility when cutting.

According to embodiments, a system, apparatus, and method are provided that increase the stability of the anvil drum by mounting the anvil drum on a pivotal support, such as a set of pivot arms (also referred to herein as pivot plates). In an exemplary embodiment, pivotal support(s), e.g., set of pivot arms, straddle each machine frame and area actuated by a pressure adjuster, which in certain exemplary embodiments includes (large) ball screw jack. The ball screw jack adjusts the cutting pressure between the two drums (i.e., the anvil drum and the die drum) or rolls. In an embodiment, a load cell, hydraulic gauge, or motor torque feedback from the linear ball screw jack motor(s) can monitor pressure.

In certain embodiments, the diameter of the die cylinder or drum is not changed (relative to conventional die cylinders) due to the machine repeat and surface speed required. In certain embodiments, the diameter of the anvil cylinder (or anvil drum) is increased relative to conventional anvil cylinders due to it having no relationship to the machine repeat as long as the surface speed matched the die drum. In embodiments, increasing the diameter of the anvil drum significantly reduced its deflection and flexibility when cutting. In exemplary embodiments, to further increase stability of the anvil drum, the die drum is mounted to a set of pivot arms. In exemplary embodiments, the pivot arms straddle each machine frame and are actuated by a large ball-screw jack. The ball-screw jack adjusts the cutting pressure between the two rolls, i.e., the die cylinder and the anvil cylinder. In embodiments, a load cell, hydraulic pressure gauge, or motor torque feedback from the linear ball screw jack motors can monitor pressure.

Advantages of certain exemplary embodiments include the system or apparatus (e.g., box making machine) experiencing less drum deflection, which in turns allows the system, such as a box-making system, apparatus, and method to run at higher speeds and make more consistent boxes and other corrugated articles. In embodiments, the less pressure required to compensate for deflection results in a more reliable die cut unit and longer-lasting tooling.

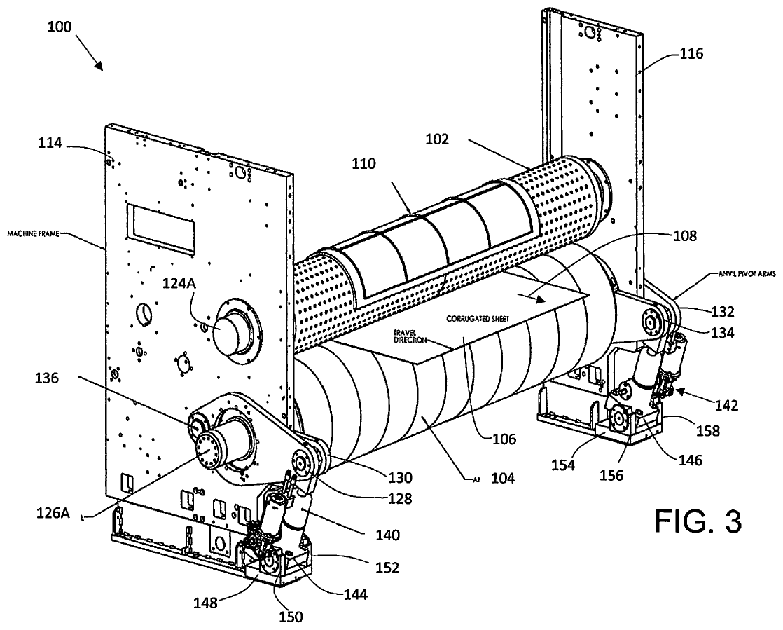

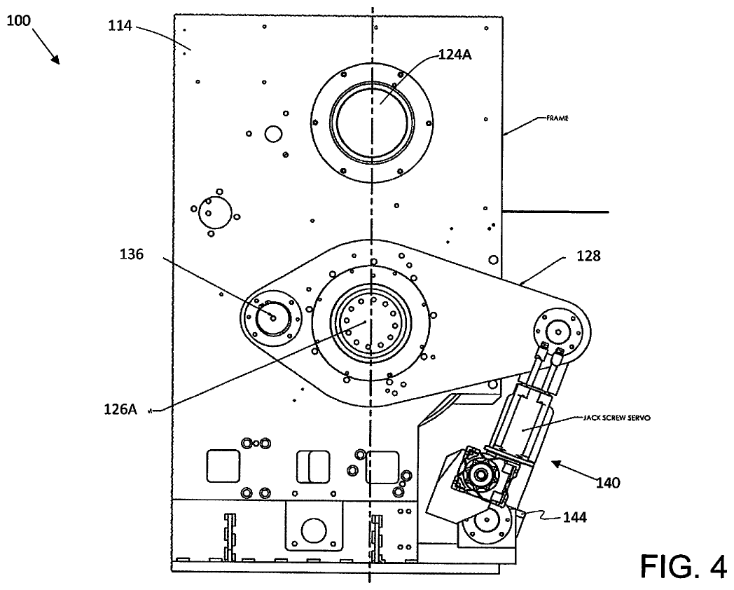

Referring now more particularly to FIG. 3, a rotary die cutting apparatus for cutting and/or creasing corrugated boards is generally designated by reference numeral 100. The rotary die cutting apparatus (also referred to herein as “apparatus” for the sake of brevity) 100 is useful in, for example, box making systems.

The apparatus 100 includes a cutting die cylinder (also referred to herein as a die drum) 102 with fixed running diameter and an anvil cylinder (also referred to herein as an anvil drum) 104. In an exemplary embodiment, the cutting die cylinder (drum) 102 and the anvil cylinder (drum) 104 have different diameters. For example, in a non-limiting embodiment, the diameters of the cutting die cylinder 102 and the anvil cylinder 104 are about 21 inches and 28 inches, respectively, with a center-to-center spacing of about 24.5 inches. The die cylinder 102 and the anvil cylinder are illustrated substantially parallel to one another and positioned (e.g., spaced) in close proximity to one another. in one or more embodiments, the spacing between the cylinders 102 and 104 is designed to receive sheet material, which in exemplary embodiments comprises a corrugated article (e.g., corrugated boards) 106. The die and anvil cylinders 102 and 104 rotate to move the corrugated article 106 in a direction of travel indicated by arrow 108.

At least part of the surface of the die cylinder 102 includes a cutting die 110 configured to cut and/or crease the corrugated articles 106 traveling in direction 108. In an embodiment, the cutting die 110 comprises steel rules designed to cut and/or crease the corrugated articles 106 against the anvil cylinder 104. It should be understood that the cutting die 110 may be embodied by structures other than steel rules. In an embodiment, an outer surface of the anvil cylinder 104 includes a cover or blanket 112. As an example, the cover or blanket 112 may be made of urethane wrapped and/or fixed to the outer surface of the anvil cylinder 104.

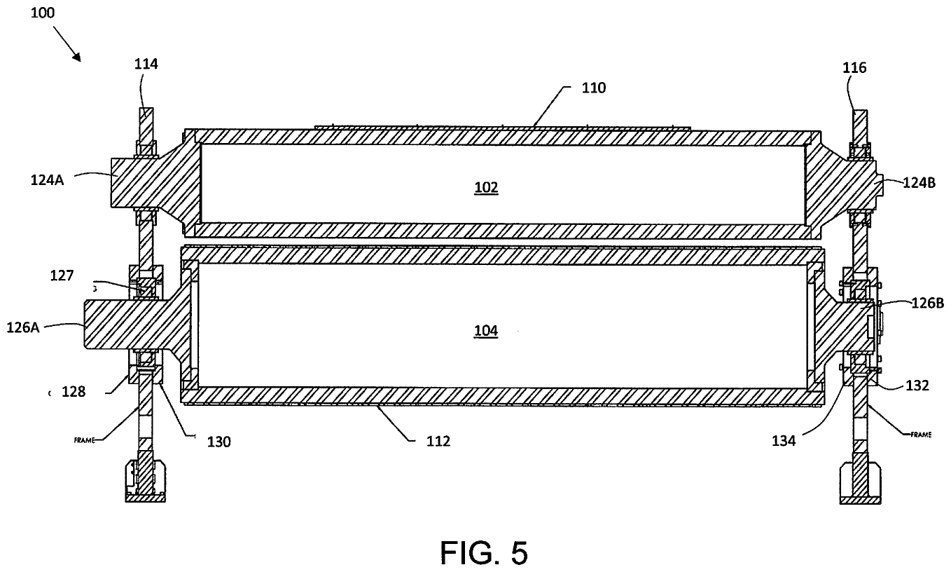

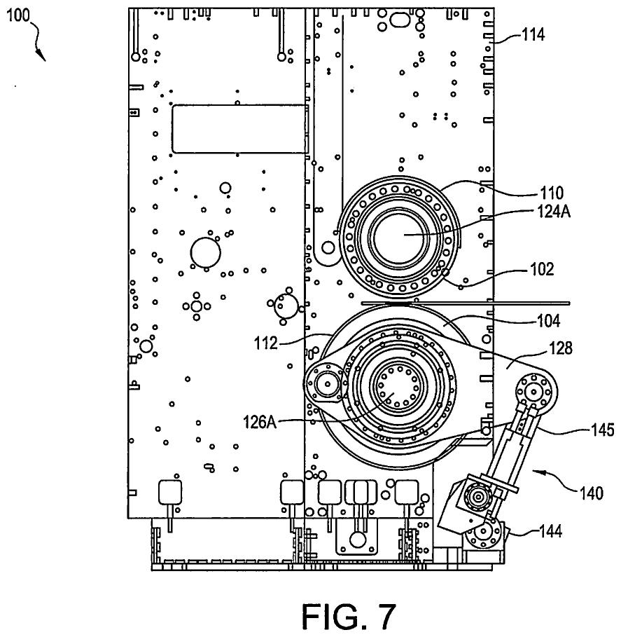

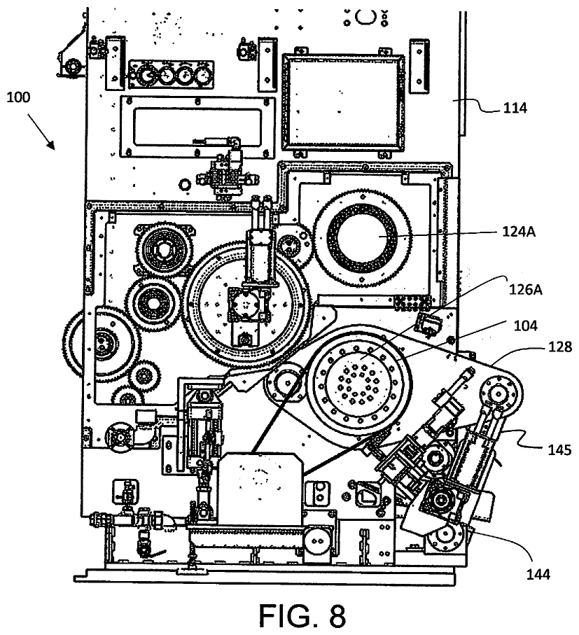

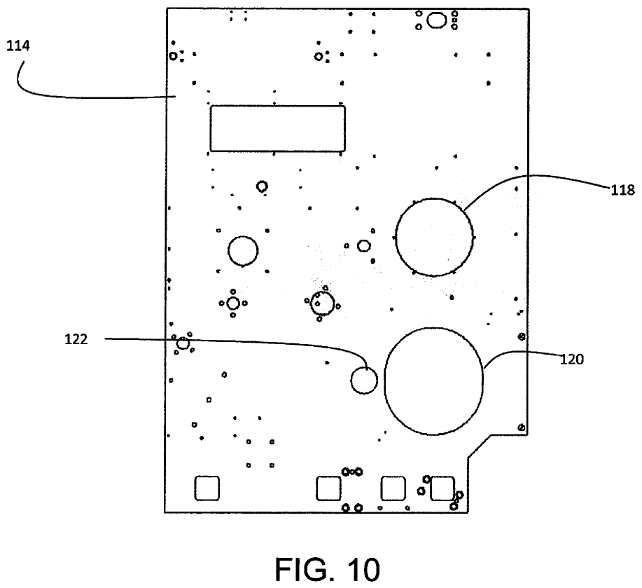

As best shown in FIGS. 5-10, the apparatus 100 further includes a first stanchion (also referred to herein as a first frame member) 114 and a second stanchion (also referred to herein as a second frame member) 116. The first and second frame members 114 and 116 are generally parallel to one another and spaced apart from one another. FIG. 10 illustrates an enlarged, isolated view of the first stanchion 114. The first stanchion 114 includes a first stanchion opening 118, a second stanchion opening 120, and a third stanchion opening 122. The second stanchion opening 120 is shaped as an elongate hole or slot. Although not shown, the second stanchion 116 may be a mirror image of the first stanchion 114. In an exemplary embodiment, the stanchion openings (e.g., 120) may be arcuate (e.g., along slightly circular in path) and substantially vertical.

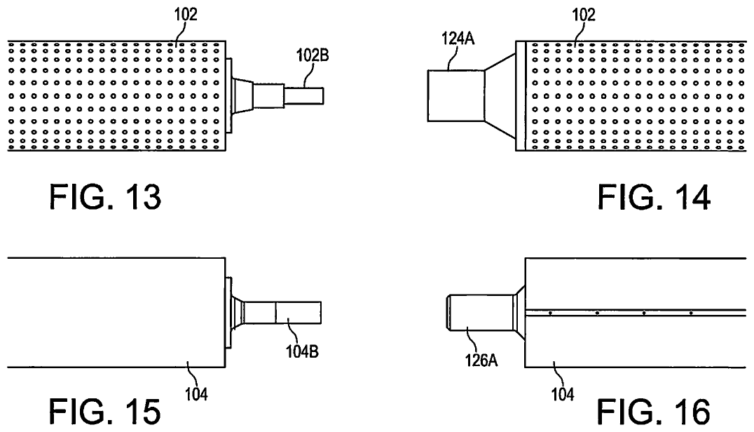

Referring now to FIGS. 5, 6, and 13-16, the die cylinder 102 includes opposing ends, one of which is illustrated and designated by reference numeral 102B in FIG. 13. The opposing ends of the die cylinder 102 are equipped with respective journals 124A and 124B depicted in, for example, FIGS. 5-8 and 14. Likewise, the anvil cylinder 104 includes opposing ends, one of which is illustrated and designated by reference numeral 104B in FIG. 15. The opposing ends of the anvil cylinder 104 are equipped with respective journals 126A and 126B depicted in, for example, FIGS. 5-8 and 16. The journaled ends 124A and 124B of the die cylinder 102 are received through the first openings 118 (see FIG. 10) of the first and second stanchions 114 and 116. The journaled ends 126A and 126B of the anvil cylinder 104 are received through the second openings 120 (see FIG. 10) of the first and second stanchions 114 and 116. FIG. 5 illustrates bearings, such as roller bearings, around the journals 124A, 124B, 126A, and 126B. An example of the bearings is designated by reference numeral 127 in FIG. 5. It should be understood that other types of bearings may be used, and that bearings may be used in connection with die cylinder 102.

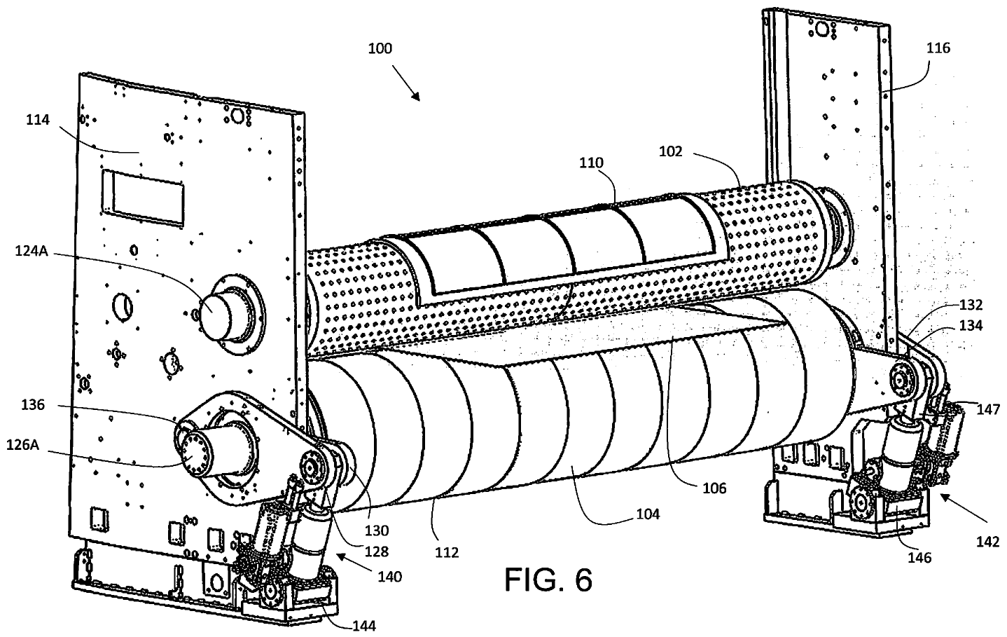

As best shown in FIGS. 3, 5, 6, 9, and 11, the apparatus 100 further includes a pair of first pivot plates (also referred to herein as first pivot arms) 128 and 130, respectively, also referred to herein as a first outer pivot plate (or arm) and a first inner pivot plate (or arm), respectively. The first outer and inner pivot plates 128 and 130, respectively, are parallel to one another and straddle the first stanchion 114, so that the first pivot plates 128 and 130 are positioned on opposite sides of the first stanchion 114. As best shown in FIGS. 5 and 6, the apparatus 100 further includes a pair of second pivot plates (also referred to herein as second pivot arms) 132 and 134, also referred to herein as a second outer pivot plate (or arm) and a second inner pivot plate (or arm), respectively. The second outer and inner pivot plates 132 and 134, respectively, are parallel to one another and straddle the second stanchion 116, so that the second pivot plates 132 and 134 are positioned on opposite sides of the second stanchion 116.

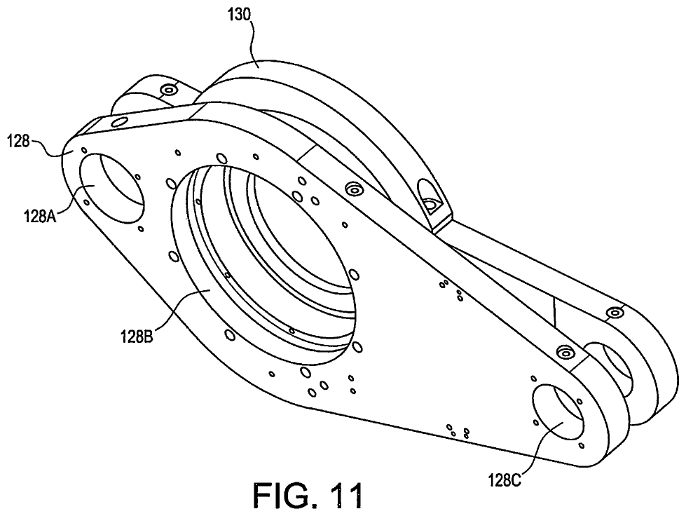

Referring now more particularly to FIG. 11, the first outer pivot plate 128 includes a series of three apertures, i.e., a first aperture 128A, a second (or central) aperture 128B, and a third aperture 128C. The first inner pivot plate 130 similarly includes a series of three corresponding apertures (unnumbered) that align with the first aperture 128A, the second (or central) aperture 128B, and the third aperture 128C, respectively. Although not shown, the second outer pivot plate 132 and the second inner pivot plate 134 are mirror images of the first outer pivot plate 128 and the first inner pivot plate 130, and include the same first, second (or central), and third corresponding apertures as their mirror images.

The first aperture 128A of the first outer pivot plate 128 and the first aperture (not shown in FIG. 11) of the first inner pivot plate 130 are aligned with the third stanchion opening 122. A first end of a pivot shaft (or a first pivot pin) 136 (see FIG. 6) is received in the aligned first aperture 128A of the first outer pivot plate 128, the first aperture of the first inner pivot plate 130, and the third stanchion opening 122 to provide a pivot point for the first outer and inner pivot plates 128 and 130, respectively. Although not shown in detail, a similar, mirror-like arrangement is found at the second stanchion 116. The first aperture of the second outer pivot plate 132 and the first aperture of the second inner pivot plate 134 are aligned with a third stanchion opening of the second stanchion 116. A second end of a pivot shaft (or a second pivot pin) is received in the aligned first aperture of the second outer pivot plate, the first aperture of the second inner pivot plate 134, and the third stanchion opening of the second stanchion 116 to provide a pivot point for the second outer and inner pivot plates 132 and 134, respectively.

Returning to FIG. 11, the second (or central) aperture 128B of the first outer pivot plate 128 and the second (or central) aperture (unnumbered) of the first inner pivot plate 130 are aligned with the second stanchion opening 120 of the first stanchion 114. A first journaled end of the anvil cylinder 104 is received in and carried by the aligned second (or central) aperture 128B of the first outer pivot plate and the second (or central) aperture of the first inner pivot plate 130, and is movable within the second stanchion opening 120. The second (or central) aperture 128B of the first outer pivot plate 128 and the second (or central) aperture of the first inner pivot plate 130 support and carry the first journaled end of the anvil cylinder 104.

Likewise, the second (or central) aperture of the second outer pivot plate 132 and the second (or central) aperture of the second inner pivot plate 134 are aligned with the second stanchion opening of the second stanchion 116. A second journaled end of the anvil cylinder 104 is received in and carried by the aligned second (or central) aperture of the second outer pivot plate 132 and the second (or central) aperture of the second inner pivot plate 134, and is movable within the second stanchion opening of the section stanchion 116. The second (or central) aperture of the second outer pivot plate 132 and the second (or central) aperture of the second inner pivot plate 134 support and carry the second journaled end of the anvil cylinder 104.

The third aperture 128C (FIG. 11) of the first outer pivot plate 128 and the third aperture (unnumbered) of the first inner pivot plate 130 are aligned with one another and pivotally connected to a first displacement actuator (also referred to as a first displacement mechanism) 140, which is shown in at least FIGS. 6-9. Likewise, a third aperture of the second outer pivot plate 132 and a third aperture of the second inner pivot plate 134 are aligned with one another and pivotally connected to a second displacement actuator (also referred to herein as a second displacement mechanism) 142, which is shown in FIGS. 3 and 6.

In an exemplary embodiment, the first and second displacement actuators 140 and 142 each comprise a ball jack screw. In other embodiments, the first displacement actuator 140 and/or the second displacement actuator 142 are a hydraulic actuator, a pneumatic actuator, a machine screw, a telescope jack, a rack and pinion, or other mechanism.

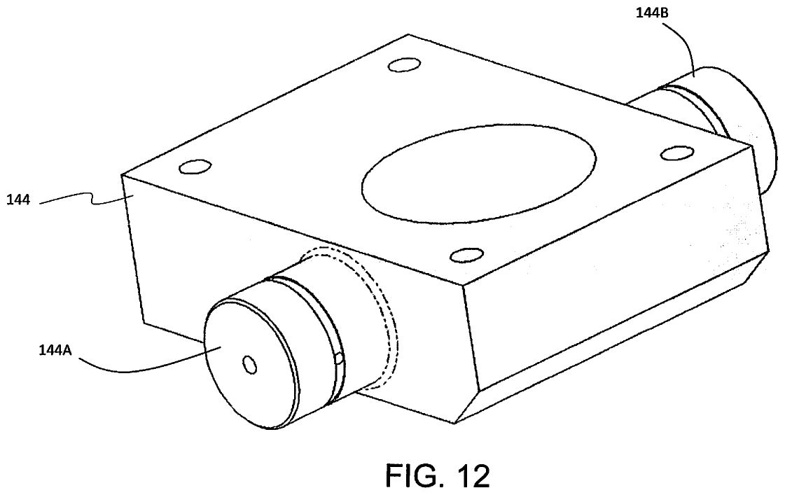

As best shown in FIGS. 3 and 6, the first displacement actuator 140 and the second displacement actuator 142 are mounted on first and second pivotal bases 144 and 146, respectively. An enlarged view of the first pivotal base 144 is shown in FIG. 12. The first pivotal base 144 includes aligned (sharing a common rotational axis) pivot pins 144A and 144B extending from opposite sides of the pivotal base 144. Although not shown in detail, the second pivotal base 144 similarly includes aligned pivot pins extending from opposite sides thereof.

As shown in FIG. 3, a first bracket 148 at or connected to the bottom of the first stanchion 114 includes yoke-like first flanges 150 and 152 that receive the pivot pins 144A and 144B of the first pivotal base 144 to permit pivotal movement of the first pivotal base 144 and the first displacement actuator 140 mounted thereon. Similarly, a second bracket 154 at or connected to the bottom of the second stanchion 116 includes yoke-like second flanges 156 and 158 that receive the pivot pins (unnumbered, but similar to the pivot pins 144A and 144B) of the second pivotal base 146 to permit pivotal movement of the second pivotal base 146 and the second displacement actuator 142 mounted thereon.

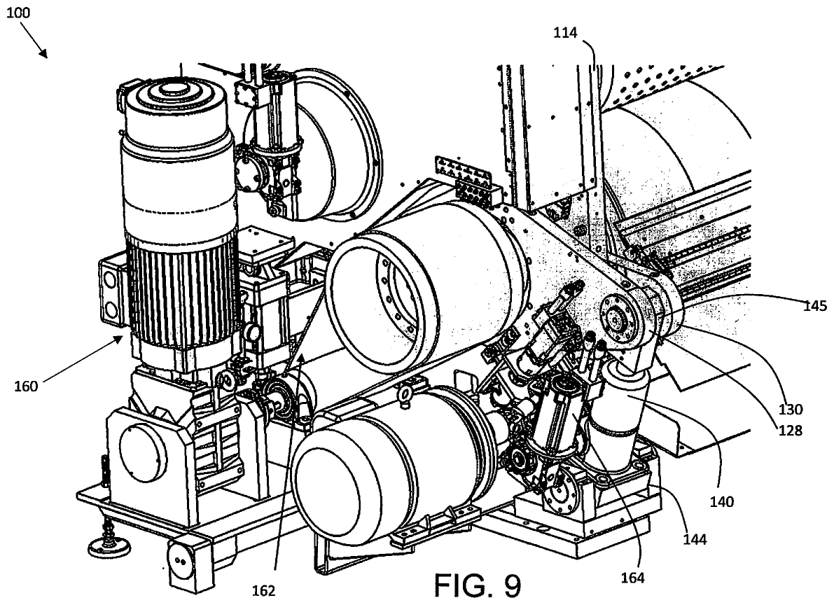

A connecting element (e.g., rod or piston) 145 (FIG. 9) of the first displacement actuator 140 is sandwiched between and pivotally connected to the first outer pivot plate 128 and the first inner pivot plate 130. Similarly, a connecting element 147 (FIG. 6) of the second displacement actuator 142 is sandwiched between and pivotally connected to the second outer pivot plate 132 and the second inner pivot plate 134.

Actuation of the first and second displacement actuators 140 and 142 may be implemented by moving the connecting elements 145 inwardly or outwardly (that is, generally upwardly or downwardly in the drawings). This actuation causes the first outer and inner pivot plates 128 and 130 (pivotably connected to the connecting element 145) to pivot about the pivot shaft (or a first pivot pin) 136 associated with the first stanchion 114 and the second outer and inner pivot plates 132 and 134 (pivotally connected to the connecting element 147) to pivot about the pivot shaft (or second pivot pin) associated with the second stanchion 116. The movement of the pivot plates 128, 130, 132, and 134 in this manner carries the anvil cylinder 104, whose journaled ends are mounted in and movable within the second (or central) apertures of the pivot plates 128, 130, 132, and 134, thereby moving the anvil cylinder 104 relative to (e.g., in closer proximity to or farther proximity from) the die cylinder 102.

In an embodiment, the first and second displacement actuators 140 and 142 (e.g., large ball screw jacks) adjust cutting pressure between the die cylinder 102 and the anvil cylinder 104 by moving the connecting elements 145 and 147 to shift the anvil cylinder 104 towards or away from the die cylinder 102. In an embodiment, controlled movement of the anvil cylinder 104 using the actuators 140 and 142 can reduce, minimize, or eliminate problems otherwise caused by wear and tear on the cover or blanket 112 of the anvil cylinder 104.

In an embodiment, a load cell, hydraulic pressure gauge, or motor torque feedback from one or both of the actuators 140 and 142 can monitor pressure. Such pressure readings can be used to control actuation of the displacement actuators 140 and 142, thereby controlling spacing between the die cylinder 102 and the anvil cylinder 104. The torque on one or more servo motors (e.g., 164 shown in FIG. 9 to the left of the displacement actuator 140 for driving the actuator 140) can be monitored. A known torque equals a known pressure at the roll nip. This information can be shown to the operator for consideration (and possible warning) of excessive pressure. Excessive pressure can be a sign of worn cutting dies or operator error. Over-pressuring the dies can cause tooling and machine damage. Other mechanisms to collect this data can include a load pad under the actuators (e.g., 140) and/or a strain gauge on the pivot arm (e.g., 128).

According to an exemplary method, as the sheets of a corrugated article, such as corrugated paper and/or corrugated boards or other articles, 106 travel between the die cylinder 102 and the anvil cylinder 104, the cutting die (e.g., blades) 110 of the die cylinder 102 penetrate at least partially through the articles 106. In cases in which the cutting die 110 penetrate through the articles 106, the cutting die 110 may further penetrate partly or completely through the cover 112 of the anvil cylinder 104 to obtain the desired cutting and scoring effect. This penetration can cause the cover 112 of the anvil cylinder 104 to wear down, reducing the overall diameter of the anvil cylinder 104. To achieve high dimensional stability of the produced corrugated boxes, both the die cylinder 102 and the anvil cylinder 104 are driven with the same surface speed.

In embodiments, as the cover 112 of the anvil cylinder 104 wears, it is desirable to increase the rotational speed of the anvil cylinder 104. The goal is to match the linear speed of the outer surface of the anvil cylinder 104 to the running linear speed of the die cylinder 102, which equals the linear speed of the corrugated sheet or articles 106 passing through the die cutter 100. Apparatus and methods of matching speeds are disclosed in, for example, the aforementioned U.S. Pat. No. 6,913,566.

In addition to matching speeds, it is desired to maintain uniform spacing between the surface of the die cylinder 102 and the surface of the anvil cylinder 104, even as the cover 112 of the anvil cylinder 104 wears away (or erodes). Exemplary embodiments of the apparatus 100 described herein provide an effective structure and method for maintaining spacing between the die cylinder 102 and 104.

Computational analysis of calculated forces may be practiced in relation to design considerations, according to an embodiment. The FEA analysis may be considered in the design of, for example, drum deflection distances. Design considerations involved in FEA analysis are within the purview of those skilled in the art.

In additional exemplary embodiments, the system and method may include additional components and steps, respectively. For example, FIG. 9 illustrates a drive motor 160 and actuating system 162 (e.g., gear(s) and drive belt) for the anvil cylinder 104 of a system of an exemplary embodiment. FIG. 9 best illustrates the motor 164 (described above), which may be, for example, a servo motor, for controlling the movement of the first displacement mechanism 140. Another motor may be provided for controlling the movement of the second displacement mechanism 142.

While particular embodiments have been shown and described, it will be understood to those skilled in the art that based upon the teachings herein, changes and modifications may be made without departing from its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claims, and in the absence of such recitation no such limitation is present. For non-limiting example, as an aid to understanding, the following appended claims may contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to the embodiments containing only one such element, even when the same claim includes the introductory phrases “one or more” or “at least one” and indefinite articles such as “a” or “an”; the same holds true for the use in the claims of definite articles. As used herein, the term “and/or” means either or both (or any combination or all of the terms or expressed referred to).

The corresponding structures, materials, acts, and equivalents of all means or step plus function elements, if any, in the claims below are intended to include any structure, material, or act for performing the function in combination with other claim elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiments were chosen and described in order to best explain the principles of the embodiments and the practical application, and to enable others of ordinary skill in the art to understand the embodiments for various embodiments with various modifications and combinations with one another as are suited to the particular use contemplated. Accordingly, the scope of protection of the embodiment(s) is limited only by the following claims and their equivalents.

Having described exemplary embodiments of a new and improved apparatus and method, it is believed that other modifications, variations and changes will be suggested to those skilled in the art in view of the teachings set forth herein. It is therefore to be understood that all such variations, modifications and changes are believed to fall within the scope of the present invention.

What is claimed is:

1. A rotary die cutting apparatus, comprising:
a rotatable first cylinder;
a rotatable second cylinder positioned in proximity to the first cylinder to compress and permit cutting and/or creasing of a corrugated article when the corrugated article passes between the first and second cylinders;
a pivot arm on which the second cylinder is mounted and configured for pivotal movement to thereby move the second cylinder mounted thereon relative to the first cylinder; and
a displacement actuator operatively connected to the pivot arm to control the pivotal movement of the pivot arm.

2. The rotary die cutting apparatus of claim 1, wherein:
the first cylinder comprises a rotatable die cylinder including at least one cutting die; and
the second cylinder comprises an anvil cylinder including at least one cover.

3. The rotary die cutting apparatus of claim 1, wherein the displacement actuator comprise a ball jack screw attached to an end portion of the pivot arm.

4. The rotary die cutting apparatus of claim 1, wherein the displacement actuator is pivotably mounted on a base.

5. The rotary die cutting apparatus of claim 1, wherein the pivot arm comprises first and second pivot plates on opposites sides of and pivotally connected to a connecting portion of the displacement actuator.

6. The rotary die cutting apparatus of claim 1, further comprising first and second stanchions on opposite ends of the first and second cylinders.

7. The rotary die cutting apparatus of claim 6, wherein:
the pivot arm has a first end region pivotally connected to the displacement actuator;
the pivot arm has a second end region connected to and pivotal relative to the first stanchion; and
the second cylinder is mounted to the pivot arm between the first end and the second end.

8. The rotary die cutting apparatus of claim 6, wherein the first cylinder has opposite ends rotatably supported by the first and second stations, respectively, and wherein the second cylinder has a first end rotatably supported by the pivot arm and a second end rotatable supported by a second pivot arm.

9. The rotary die cutting apparatus of claim 1, further comprising a feedback loop for monitoring motor torque and controlling the displacement actuator to maintain relatively uniform spacing between the die cylinder and the anvil cylinder during operation.

10. A method of operating a rotary die cutting apparatus, comprising:
providing the rotary die cutting apparatus, the rotary die cutting apparatus comprising:
a rotatable first cylinder;
a rotatable second cylinder positioned in proximity to the first cylinder to compress and permit cutting and/or creasing of a corrugated article when the corrugated article passes between the first and second cylinders;
a pivot arm on which the second cylinder is mounted and configured for pivotal movement to thereby move the second cylinder mounted thereon relative to the first cylinder; and
a displacement actuator operatively connected to the pivot arm to control the pivotal movement of the pivot arm; and
passing an article between the first and second cylinders to cause the first cylinder and/or the second cylinder to cut and/or crease the article.

11. The method of claim 10, wherein the article comprises a corrugated board.

12. The method of claim 10, wherein:
the first cylinder comprises a rotatable die cylinder including at least one cutting die; and
the second cylinder comprises an anvil cylinder including at least one cover.

13. The method of claim 10, wherein the displacement actuator comprise a ball jack screw attached to an end portion of the pivot arm.

14. The method of claim 10, wherein the displacement actuator is pivotably mounted on a base.

15. The method of claim 10, wherein the pivot arm comprises first and second pivot plates on opposites sides of and pivotally connected to a connecting portion of the displacement actuator.

16. The method of claim 10, further comprising first and second stanchions on opposite ends of the first and second cylinders.

17. The method of claim 10, wherein:
the pivot arm has a first end region pivotally connected to the displacement actuator;
the pivot arm has a second end region connected to and pivotal relative to the first stanchion; and
the second cylinder is mounted to the pivot arm between the first end and the second end.

18. The method of claim 16, wherein the first cylinder has opposite ends rotatably supported by the first and second stations, respectively, and wherein the second cylinder has a first end rotatably supported by the pivot arm and a second end rotatable supported by a second pivot arm.

19. The method of claim 10, further comprising operating the displacement actuator to maintain relatively uniform spacing between the die cylinder and the anvil cylinder during operation.
